(19) United States
(12) Patent Application Publication
(10) Pub. No.: US 2018/0212469 A1
(43) Pub. Date: Jul. 26, 2018

(54) MULTI-MODE WIRELESS POWER RECEIVER CIRCUIT AND CONTROL METHOD THEREOF

(71) Applicant: RICHTEK TECHNOLOGY CORPORATION, Zhubei City (TW)

(72) Inventors: Kuo-Chi Liu, Hsiinchu (TW); Chi-Min Lee, Zhubei City (TW)

(21) Appl. No.: 15/611,267

(22) Filed: Jun. 1, 2017

(30) Foreign Application Priority Data
Jan. 22, 2017 (CN) 201710052997.9

(51) Int. Cl. H02J 50/12; H04B 5/00; H02J 50/80

(52) U.S. Cl. CPC H02J 50/12; H02J 50/80; H04B 5/0037

(57) ABSTRACT

The present invention provides a multi-mode wireless power receiver circuit which includes a first and a second resonant circuits, a first and a second rectifier circuits, a DC-DC conversion circuit, and an output power control circuit. The first and the second resonant circuits receive a first and a second wireless power to generate a first and a second AC resonant signals respectively. The first and the second rectifier circuits rectify the first and the second AC resonant signals to generate a first and a second rectified output signals respectively. The DC-DC conversion circuit converts the second rectified output signal into a DC output signal. The output power control circuit combines the DC output signal and the first rectified output signal to generate a system output signal, and controls the DC-DC conversion circuit by a conversion control signal to adjust the system output signal such that the system output signal meets a power requirement.

### CROSS REFERENCE

The present invention claims priority to CN 201710052997.9, filed on Jan. 22, 2017.

### BACKGROUND OF THE INVENTION

### Field of Invention

The present invention relates to a wireless power receiver circuit; particularly, it relates to a wireless power receiver circuit supporting multiple modes. The present invention also relates to a control method for use in the wireless power receiver circuit.

### Description of Related Art

FIG. 1 shows a prior art multi-mode wireless power receiver circuit (wireless power receiver circuit 1) disclosed by “MediaTek, A. Satyamoorthy, etc., Wireless Power Receiver for Mobile Devices Supporting Inductive and Resonant Operating Modes”, IEEE WPTC, pp. 52-55, 2014”, which supports both inductive and resonant wireless power receiver modes. The resonant circuit of the wireless power receiver circuit 1 includes two coils connected in series, and is coupled to a rectifier, wherein one of the coils is configured to operate in low frequency inductive operation mode, and the other coil is configured to operate in high frequency resonant operation mode.

FIG. 2 shows another prior art multi-mode wireless power receiver circuit (wireless power receiver circuit 2) disclosed by “MAPS, J. T. Hwang, etc., An All-in-One (Qi, PMA and A4WP) 2.5 W Fully Integrated Wireless Battery Charger IC for Wearable Applications, ISSCC, pp. 378-380, 2016”, which also supports both inductive and resonant wireless receiver modes. The resonant circuit of the wireless power receiver circuit 1 includes two coils connected in parallel, and is coupled to a rectifier, wherein one of the coils is configured to operate in low frequency inductive operation mode, and the other coil is configured to operate in high frequency resonant operation mode.

The prior art circuits in FIGS. 1 and 2 have a drawback that the resonant circuit may generate overly high voltage in some circumstances and damage the rectifiers and controllers thereof, while in some other circumstances the voltage generated by the resonant circuit may be too low that it does not meet the requirement of the load circuit. Therefore, it is not easy to design the resonant circuits and choose the inductive coils of proper specifications.

Compared to the prior art in FIGS. 1 and 2, the present invention is advantageous in being able to adaptively select, or combine, or adjust the voltage or power received so as to meet different requirements in different modes, and it is easy to design the resonant circuits and choose the inductive coils of proper specifications.

### SUMMARY OF THE INVENTION

From one perspective, the present invention provides a multi-mode wireless power receiver circuit, comprising: a first resonant circuit which includes at least a first receiver coil, and is configured to operably receive a first wireless power transmitted by a first wireless power transmitter circuit and convert the first wireless power into a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; a DC-DC power conversion circuit, configured to operably convert the second rectified output signal into a DC output signal, wherein the DC output signal includes a DC output voltage and a DC output current; and an output power control circuit which is coupled to the first rectifier circuit and the DC-DC conversion circuit, and is configured to operably select one of or combine the DC output signal and the first rectified output signal to generate a system output signal; wherein the output power control circuit generates a conversion control signal to control the DC-DC conversion circuit to adjust the system output signal for meeting a power requirement; wherein the first resonant frequency is different from the second resonant frequency.

In one embodiment, the output power control circuit selects one of or combines the DC output signal and first rectified output signal to generate the system output signal according to information (1) and (2) below: (1) the second rectified output voltage, and/or the second rectified output current, and/or the DC output voltage, and/or the DC output current; and (2) the first rectified output voltage, and/or the first rectified output current; wherein the output power control circuit generates the conversion control signal according to the information (1) and (2) to control the DC-DC conversion circuit.

From another perspective, the present invention provides a multi-mode wireless power receiver circuit, comprising: a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; an output power control circuit which is coupled to the first rectifier circuit and the second rectifier circuit, and is configured to operably select one of or combine the second rectified output signal and the first rectified output signal to generate a combined output signal; and a DC-DC power conversion circuit, configured to operably convert the combined output signal into a system output signal; wherein the output power control circuit generates a conversion control signal to control the DC-DC conversion circuit to adjust the system output signal for meeting a power requirement; wherein the first resonant frequency is different from the second resonant frequency.

In one embodiment, the output power control circuit selects one of or combines the second rectified output signal and the first rectified output signal to generate the combined output signal according to information (1) and (2) below: (1) the second rectified output voltage, and/or the second rectified output current; and (2) the first rectified output voltage, and/or the first rectified output current; wherein the output power control circuit generates the conversion control signal according to the information (1) and (2) to control the DC-DC conversion circuit.

In one embodiment, the DC-DC conversion circuit is a linear regulator circuit, a switching buck converter circuit, a switching boost converter circuit, or a switching buck-boost converter circuit.

In one embodiment, the output power control circuit generates an over voltage protection signal according to the first rectified output voltage to control a first protection switch of the first resonant circuit for adjusting an impedance of the first or the second resonant circuit for over voltage protection, or generates an over voltage protection signal according to the second rectified output voltage to control a second protection switch of the second resonant circuit for adjusting an impedance of the second resonant circuit for over voltage protection.

In one embodiment, the output power control circuit generates a communication control signal to control a first communication switch of the first resonant circuit to adjust an impedance of the first resonant circuit for executing an in-band communication with the first wireless power transmitter circuit, or generates a communication control signal to control a second communication switch of the second resonant circuit to adjust an impedance of the second resonant circuit for executing an in-band communication with the second wireless power transmitter circuit.

In one embodiment, the output power control circuit generates a communication control signal to control an out-of-band communication circuit for executing an out-of-band communication with the first wireless power transmitter circuit or the second wireless power transmitter circuit.

In one embodiment, the output power control circuit generates an impedance control signal to control a first variable capacitor circuit of the first resonant circuit for controlling an impedance of the first resonant circuit to adjust the first resonant frequency or generates an impedance control signal to control a second variable capacitor circuit of the second resonant circuit for controlling an impedance of the second resonant circuit to adjust the second resonant frequency; wherein each of the first variable capacitor circuit and the second variable capacitor circuit includes: (1) a varactor diode; or (2) a capacitor and an impedance control switch connected in series or in parallel.

From another perspective, the present invention provides a control method for use in controlling a multi-mode wireless power receiver circuit which comprises: a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; and a DC-DC power conversion circuit, configured to operably convert the second rectified output signal into a DC output signal, wherein the DC output signal includes a DC output voltage and a DC output current; wherein the first resonant frequency is different from the second resonant frequency; the control method comprising: selecting one of or combining the DC output signal and the first rectified output signal to generate a system output signal; and generating a conversion control signal to control the DC-DC conversion circuit to adjust the system output signal for meeting a power requirement.

In one embodiment, the control method selects one of or combines the DC output signal and first rectified output signal to generate the combined output signal according to information (1) and (2) below: (1) the second rectified output voltage, and/or the second rectified output current, and/or the DC output voltage, and/or the DC output current; and (2) the first rectified output voltage, and/or the first rectified output current; and the control method generates the conversion control signal according to the information (1) and (2) to control the DC-DC conversion circuit.

From another perspective, the present invention provides a control method for use in controlling a multi-mode wireless power receiver circuit which comprises: a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; and a DC-DC power conversion circuit, configured to operably convert a combined output signal into a system output signal; wherein the first resonant frequency is different from the second resonant frequency; the control method comprising: selecting one of or combining the second rectified output signal and the first rectified output signal to generate the combined output signal; generating a conversion control signal to control the DC-DC conversion circuit to adjust the system output signal for meeting a power requirement.

In one embodiment, the control method selects one of or combines the second rectified output signal and the first rectified output signal to generate the combined output signal according to information (1) and (2) below: (1) the second rectified output voltage, and/or the second rectified output current; and (2) the first DC output voltage, and/or the first rectified output current; and the control method generates the conversion control signal according to the information (1) and (2) to control the DC-DC conversion circuit.

In one embodiment, the control method generates an over voltage protection signal according to the first rectified output voltage to control a first protection switch of the first resonant circuit for adjusting an impedance of the first or the second resonant circuit for over voltage protection, or generates an over voltage protection signal according to the second rectified output voltage to control a second protection switch of the second resonant circuit for adjusting an impedance of the second resonant circuit for over voltage protection.

In one embodiment, the control method generates a communication control signal to control a first communication switch of the first resonant circuit to adjust an impedance of the first resonant circuit for executing an in-band communication with the first wireless power transmitter circuit, or generates a communication control signal to control a second communication switch of the second resonant circuit to adjust an impedance of the second resonant circuit for executing an in-band communication with the second wireless power transmitter circuit.

In one embodiment, the control method generates a communication control signal to control an out-of-band communication circuit for executing an out-of-band communication with the first wireless power transmitter circuit or the second wireless power transmitter circuit.

In one embodiment, the control method wherein the output power control circuit generates an impedance control signal to control a first variable capacitor circuit of the first resonant circuit for controlling an impedance of the first resonant circuit to adjust the first resonant frequency or generates an impedance control signal to control a second variable capacitor circuit of the second resonant circuit for controlling an impedance of the second resonant circuit to adjust the second resonant frequency; wherein each of the first variable capacitor circuit and the second variable capacitor circuit includes: (1) a varactor diode; or (2) a capacitor and an impedance control switch connected in series or in parallel.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art multi-mode wireless power receiver circuit.

FIG. 2 shows a schematic diagram of a prior art multi-mode wireless power receiver circuit.

FIG. 3 shows a schematic diagram of an embodiment of the multi-mode wireless power receiver circuit according to the present invention.

FIG. 4 shows a schematic diagram of an embodiment of the multi-mode wireless power receiver circuit according to the present invention.

FIG. 5 shows a schematic diagram of an embodiment of the multi-mode wireless power receiver circuit according to the present invention.

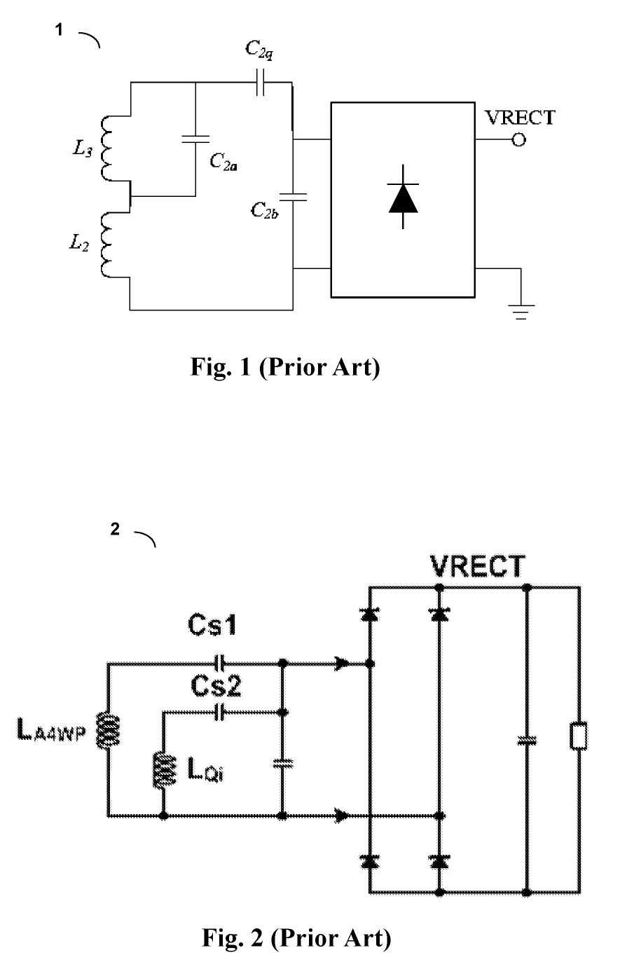

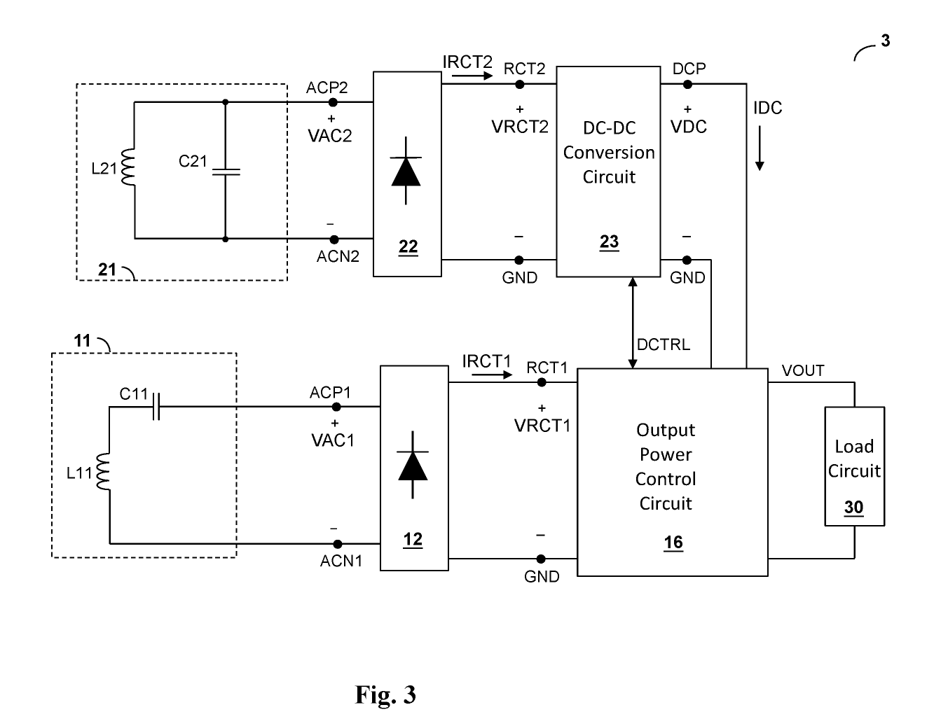

### DESCRIPTION OF THE PREFERRED EMBODIMENTS

The drawings as referred to throughout the description of the present invention are for illustration only, to show the interrelations between the circuits and the signal waveforms, but not drawn according to actual scale.

FIG. 3A shows one embodiment of the multi-mode wireless power receiver circuit according to the present invention (multi-mode wireless power receiver circuit 3), wherein the multi-mode wireless power receiver circuit 3 comprises a first resonant circuit 11, a first rectifier circuit 12, a second resonant circuit 21, a second rectifier circuit 22, a DC-DC power conversion circuit 23, and an output power control circuit 16. The first resonant circuit 11 includes at least a first receiver coil L11 and a resonant capacitor C11, and is configured to operably receive a first wireless power (not shown) transmitted by a first wireless power transmitter circuit (not shown) and convert the first wireless power to a first AC resonant signal VAC1, wherein the first resonant circuit 11 has a first resonant frequency FR1. The first rectifier circuit 12 is coupled to the first resonant circuit 11, and is configured to operably rectify the first AC resonant signal VAC1 into a first rectified output signal between a first rectified output node RCT1 and a ground node GND, wherein the first rectified output signal includes a first rectified output voltage VRCT1 and a first rectified output current IRCT1. The second resonant circuit 21 includes at least a second receiver coil L21 and a resonant capacitor C21, and is configured to operably receive a second wireless power (not shown) transmitted by a second wireless power transmitter circuit (not shown) and convert the second wireless power to a second AC resonant signal VAC2, wherein the second resonant circuit 21 has a second resonant frequency FR2. The second wireless power and the second wireless power transmitter circuit can be the same or different from the first wireless power and first wireless power transmitter circuit. The second rectifier circuit 22 is coupled to the second resonant circuit 21, and is configured to operably rectify the second AC resonant signal VAC2 into a second rectified output signal between a second rectified output node RCT2 and the ground node GND, wherein the second rectified output signal includes a second rectified output voltage VRCT2 and a second rectified output current IRCT2. The DC-DC power conversion circuit 23 is configured to operably convert the second rectified output signal into a DC output signal between a DC output node DCP and the ground node GND, wherein the DC output signal includes a DC output voltage VDC and a DC output current IDC. The output power control circuit 16 is coupled to the first rectifier circuit 12 and the DC-DC conversion circuit 23, and is configured to operably select one of or combine the DC output signal and the first rectified output signal to generate a system output signal VOUT, wherein the output power control circuit 16 generates a conversion control signal DCTRL to control the DC-DC conversion circuit 23 to adjust the system output signal VOUT for meeting a power requirement of a load circuit 30.

The term “combine” means combining for example but not limited to the voltages, and/or currents, and/or power of the two signals by way of direct coupling or indirect coupling (for example through at least a diode or at least a switch), when these two signals are combinable. And, the aforementioned “power requirement of a load circuit” for example may include requirements for a target, average, maximum, minimum, etc. of voltage, current, and/or power.

In one embodiment, the first resonant frequency FR1 and the second resonant frequency FR2 may be different. For example, the first resonant circuit 11 may be for example but not limited to an inductive mode resonant circuit of which the resonant frequency is relatively lower. And the second resonant circuit 21 may be for example but not limited to a resonance mode resonant circuit, of which the resonant frequency is relatively higher. However, this is only an illustrative example. In another embodiment, the first resonant frequency FR1 and the second resonant frequency FR2 may be the same. Under this circumstance, the multi-mode wireless power receiver circuit of the present invention may be configured to receive wireless power with the same mode in parallel, and can receive and deliver relatively higher power in the same wireless power mode.

Still referring to FIG. 3, the output power control circuit 16 selects one of or combines the DC output signal and first rectified output signal to generate the system output signal VOUT according to information (1) and (2) below: (1) the second rectified output voltage VRCT2, and/or the second rectified output current IRCT2, and/or the DC output voltage VDC, and/or the DC output current IDC; and (2) the first rectified output voltage VRCT1, and/or the first rectified output current IRCT1. More specifically, the output power control circuit 16 generates the conversion control signal DCTRL according to the above information (1) and (2) to control the DC-DC conversion circuit 23 for meeting the aforementioned requirements.

Still referring to FIG. 3, the DC-DC conversion circuit 23 may be for example but not limited to a linear regulator circuit, or a switching buck converter circuit, or a switching boost converter circuit, or a switching buck-boost converter circuit. In one preferred embodiment, the DC-DC conversion circuit 23 is a switching buck-boost converter circuit, wherein when the second rectified output voltage VRCT2 is higher than the target of the DC output voltage VDC, the DC-DC conversion circuit 23 can execute buck conversion to convert the second rectified output voltage VRCT2 down to the DC output voltage VDC, and when the second rectified output voltage VRCT2 is lower than the target of the DC output voltage VDC, the DC-DC conversion circuit 23 can execute boost conversion to convert the second rectified output voltage VRCT2 up to the DC output voltage VDC. In one embodiment, the rectifier circuit (the first rectifier circuit 12 and/or the second rectifier circuit 22) may be for example but not limited to a full bridge or half bridge rectifier circuit, or a synchronized full bridge or half bridge rectifier circuit (bridge rectifier circuits embodied by switches).

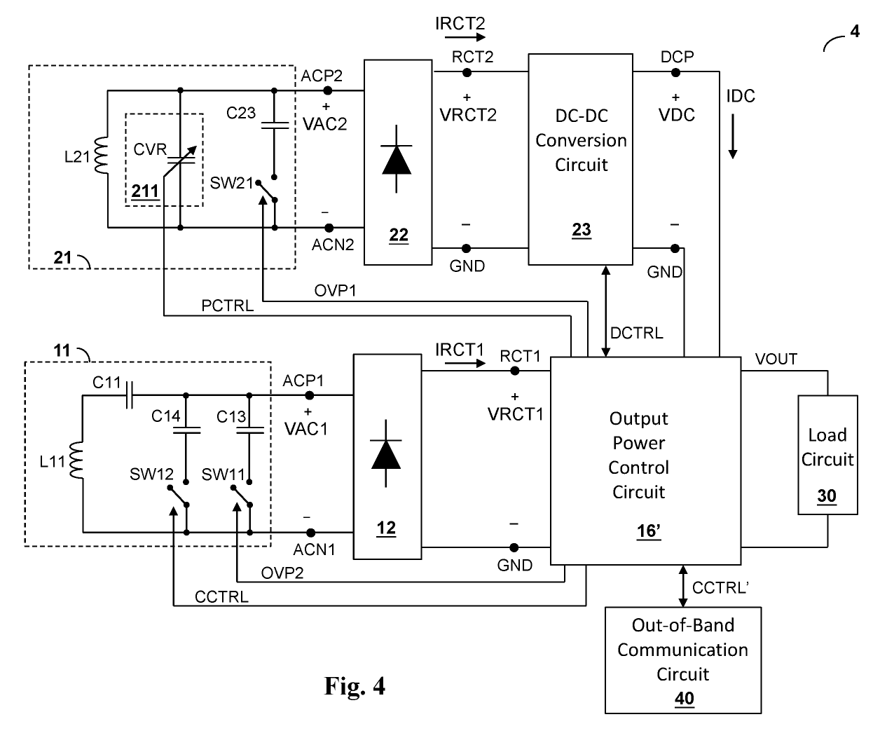

Referring to FIG. 4 which shows a schematic diagram of an embodiment of the multi-mode wireless power receiver circuit (multi-mode wireless power receiver circuit 4) according to the present invention. In the multi-mode wireless power receiver circuit 4, the output power control circuit 16 generates an over voltage protection signal OVP (for example OVP1) according to the first rectified output voltage VRCT1 to control a first protection switch SW11 of the first resonant circuit 11 for adjusting an impedance or the first resonant frequency FR1 of the first resonant circuit 11, and/or generates an over voltage protection signal OVP (for example OVP2) according to the second rectified output voltage VRCT2 to control a second protection switch SW21 for adjusting an impedance or the second resonant frequency FR2 of the second resonant circuit 21, for over voltage protection (by way of controlling the coupling of the C13 and C23). Note that in other embodiments, the aforementioned goal can also be achieved by providing a protection resistor or another type of device connected in series or in parallel with the resonant circuits, and controlling the connection or resistance of this resistor or device. In another embodiment, the over voltage protection can also be achieved by controlling the protection switch SW11 or SW21 to open the loop (for example by disconnecting the coupling between the AC resonant signal and the rectifier circuit).

Still referring to FIG. 4, in one embodiment, the output power control circuit 16′ generates a communication control signal CCTRL to control a first communication switch SW12 of the first resonant circuit 11 to adjust the impedance or the resonant frequency FR1 (by controlling the coupling of C14 in this embodiment) of the first resonant circuit 11 for executing an in-band communication with the first wireless power transmitter circuit. Note that the above is only one possible embodiment and the communication switch SW12 is not limited to being coupled with the capacitor C14; for example, in another embodiment, it can be coupled to a communication resistor or another type of device, and the communication signal CCTRL can control the switch or the device to change the impedance or the resonant frequency FR1 of the resonant circuit 11 and achieve the same function. Besides, the aforementioned in-band communication can also be embodied in the second resonant circuit 12, wherein the second resonant circuit 12 can be equipped with a circuit similar to the communication switch SW12 and the capacitor C14 in the resonant circuit 11 and the communication control signal CCTRL can be used in controlling a the communication switch of the second resonant circuit 12.

In addition to the aforementioned in-band communication with the wireless power transmitter circuit, the multi-mode wireless power receiver circuit can also execute an out-of-band communication. Still referring to FIG. 4, in one embodiment, the output power control circuit 16′ generates a communication control signal CCTRL′ to control an out-of-band communication circuit 40 for executing an out-of-band communication with the first wireless power transmitter circuit or the second wireless power transmitter circuit.

Still referring to FIG. 4, in one embodiment, the output power control circuit 16′ generates an impedance control signal PCTRL to control an impedance of a first variable capacitor circuit of the first resonant circuit 11 to adjust the impedance of the first resonant circuit 11 so as to adjust the first resonant frequency FR1, or generates an impedance control signal PCTRL to control an impedance of a second variable capacitor circuit 211 of the second resonant circuit 21 to adjust the impedance of the second resonant circuit 21 so as to adjust the second resonant frequency FR2. For simplicity of the drawing, only the second variable capacitor circuit 211 is shown, while the same circuit can be embodied in the first resonant circuit 11. Each of the first variable capacitor circuit and the second variable capacitor circuit 211 may include: (1) a varactor (CVR), or (2) a capacitor and an impedance switch connected in series or in parallel. The varactor CVR may be a voltage controlled varactor diode, wherein a capacitance of the varactor can be adjusted continuously (non-stepwisely) and in an analog way by controlling a reverse bias of the varactor CVR. In this case, the aforementioned impedance control signal PCTRL may correspondingly be an analog control signal such that the impedance of the first or the second resonant circuit and the first resonant frequency FR1 or the second resonant frequency FR2 can also be adjusted continuously (non-stepwisely) in an analog way.

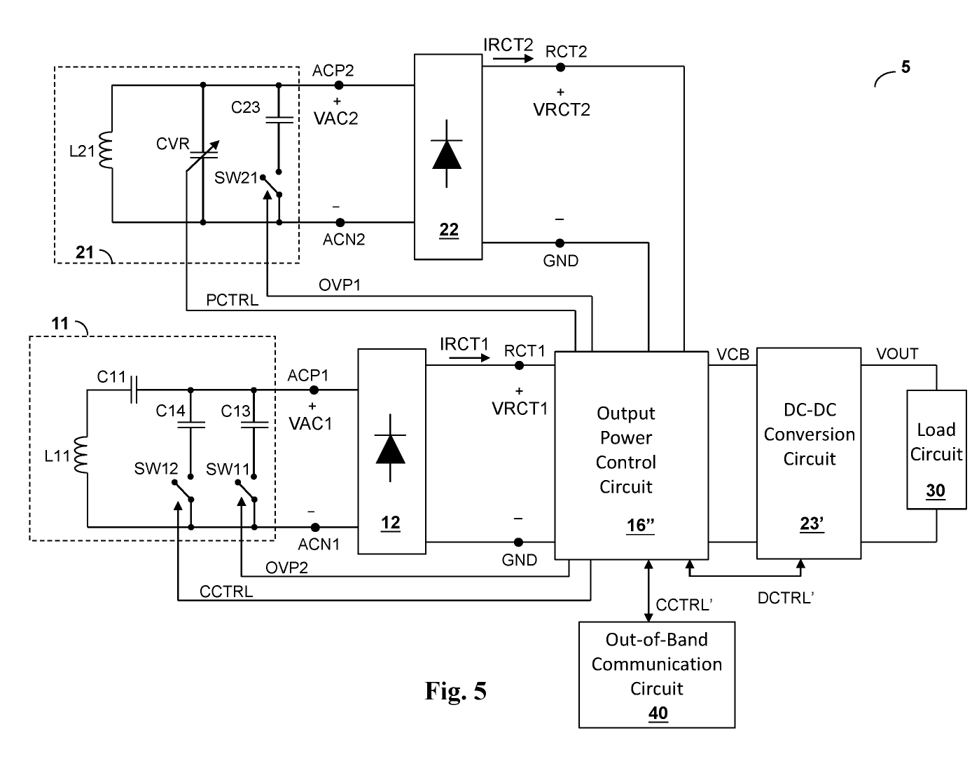

The aforementioned output power control circuit and the DC-DC conversion circuit of the present invention can be coupled in other configurations for achieving the same functions as described above. Referring to FIG. 5 which shows a schematic diagram of an embodiment of the multi-mode wireless power receiver circuit (multi-mode wireless power receiver circuit 5) according to the present invention. This embodiment is similar to the multi-mode wireless power receiver circuit 4, but is different in that the output power control circuit 16″ is coupled to the first rectifier circuit 12 and the second rectifier circuit 22, and is configured to operably select one of or combine the second rectified output signal and the first rectified output signal to generate a combined output signal VCB, and that the DC-DC power conversion circuit 23′ is configured to operably convert the combined output signal VCB into a system output signal VOUT. Besides, the output power control circuit 16″ also generates a conversion control signal DCTRL′ to control the DC-DC conversion circuit 23′ to adjust the system output signal VOUT for meeting the aforementioned load power requirement.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. As an example, the “over voltage protection” and the “in-band communication” can be used together, such that the multi-mode wireless power receiver circuit can have these two functions at the same time. As another example, the “in-band” communication and the “out-of-band communication” can be used together to communicate separately or jointly with these two different communication channels. The multi-mode wireless receiver circuit may include circuits corresponding to the above functions realize the combinations described above. Furthermore, those skilled in this art can readily conceive variations and modifications within the spirit of the present invention. For example, in the aforementioned embodiments, the resonant circuit is embodied by a series resonant circuit (e.g. the resonant circuit 11 in FIG. 3) or a parallel resonant circuit (e.g. the resonant circuit 21 in FIG. 3); however, the resonant circuit may be embodied by other kinds of resonant circuits such as a combination of a series resonant circuit and a parallel resonant circuit. As another example, the aforementioned embodiments are illustrated with two wireless power modes and therefore include two groups of resonant circuits and rectifier circuits only; however, the multi-mode wireless receiver circuit can also include three or more groups of resonant circuits and rectifier circuits to receive three or more wireless power. In this case, one or more DC-DC conversion circuits can be added correspondingly when necessary. As another example, the “variable capacitor circuit” and the “in-band communication” of the aforementioned embodiments are included in the first resonant circuit and the second resonant circuit respectively. However, this arrangement is for illustration but not for limiting the scope of the present invention, that is, a resonant circuit can include either one of both of the “variable capacitor circuit” and/or the “in-band communication”. As another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. The spirit of the present invention should cover all such and other modifications and variations, which should be interpreted to fall within the scope of the following claims and their equivalents.

What is claimed is:

1. A multi-mode wireless power receiver circuit, comprising:
a first resonant circuit which includes at least a first receiver coil, and is configured to operably receive a first wireless power transmitted by a first wireless power transmitter circuit and convert the first wireless power into a first AC resonant signal, wherein the first resonant circuit has a first resonant frequency;
a first rectifier circuit which is coupled to the first resonant circuit, and is configured to operably rectify the first AC resonant signal into a first rectified output signal, wherein the first rectified output signal includes a first rectified output voltage and a first rectified output current;
a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency;
a second rectifier circuit which is coupled to the second resonant circuit, and is configured to operably rectify the second AC resonant signal into a second rectified output signal, wherein the second rectified output signal includes a second rectified output voltage and a second rectified output current;
a DC-DC power conversion circuit, configured to operably convert the second rectified output signal into a DC output signal, wherein the DC output signal includes a DC output voltage and a DC output current; and
an output power control circuit which is coupled to the first rectifier circuit and the DC-DC conversion circuit, and is configured to operably select one of or combine the DC output signal and the first rectified output signal to generate a system output signal;
wherein the output power control circuit generates a conversion control signal to control the DC-DC conversion circuit to adjust the system output signal for meeting a power requirement;
wherein the first resonant frequency is different from the second resonant frequency.

2. The multi-mode wireless power receiver circuit of claim 1, wherein the output power control circuit selects one of or combines the DC output signal and first rectified output signal to generate the system output signal according to information (1) and (2) below:
(1) the second rectified output voltage, and/or the second rectified output current, and/or the DC output voltage, and/or the DC output current; and
(2) the first rectified output voltage, and/or the first rectified output current;
wherein the output power control circuit generates the conversion control signal according to the information (1) and (2) to control the DC-DC conversion circuit.

3. The multi-mode wireless power receiver circuit of claim 1, wherein the DC-DC conversion circuit is a linear regulator circuit, a switching buck converter circuit, a switching boost converter circuit, or a switching buck-boost converter circuit.

4. The multi-mode wireless power receiver circuit of claim 1, wherein the output power control circuit generates an over voltage protection signal according to the first rectified output voltage to control a first protection switch of the first resonant circuit for adjusting an impedance of the first or the second resonant circuit for over voltage protection, or generates an over voltage protection signal according to the second rectified output voltage to control a second protection switch of the second resonant circuit for adjusting an impedance of the second resonant circuit for over voltage protection.

5. The multi-mode wireless power receiver circuit of claim 1, wherein the output power control circuit generates a communication control signal to control a first communication switch of the first resonant circuit to adjust an impedance of the first resonant circuit for executing an in-band communication with the first wireless power transmitter circuit, or generates a communication control signal to control a second communication switch of the second resonant circuit to adjust an impedance of the second resonant circuit for executing an in-band communication with the second wireless power transmitter circuit.

6. The multi-mode wireless power receiver circuit of claim 1, wherein the output power control circuit generates a communication control signal to control an out-of-band communication circuit for executing an out-of-band communication with the first wireless power transmitter circuit or the second wireless power transmitter circuit.

7. The multi-mode wireless power receiver circuit of claim 1, wherein the output power control circuit generates an impedance control signal to control a first variable capacitor circuit of the first resonant circuit for controlling an impedance of the first resonant circuit to adjust the first resonant frequency or generates an impedance control signal to control a second variable capacitor circuit of the second resonant circuit for controlling an impedance of the second resonant circuit to adjust the second resonant frequency; wherein each of the first variable capacitor circuit and the second variable capacitor circuit includes:
(1) a varactor diode; or
(2) a capacitor and an impedance control switch connected in series or in parallel.

8. A multi-mode wireless power receiver circuit, comprising:
a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency;
a first rectifier circuit which is coupled to the first resonant circuit, and is configured to operably rectify the first AC resonant signal into a first rectified output signal, wherein the first rectified output signal includes a first rectified output voltage and a first rectified output current;
a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency;
a second rectifier circuit which is coupled to the second resonant circuit, and is configured to operably rectify the second AC resonant signal into a second rectified output signal, wherein the second rectified output signal includes a second rectified output voltage and a second rectified output current;
an output power control circuit which is coupled to the first rectifier circuit and the second rectifier circuit, and is configured to operably select one of or combine the second rectified output signal and the first rectified output signal to generate a combined output signal; and
a DC-DC power conversion circuit, configured to operably convert the combined output signal into a system output signal;
wherein the output power control circuit generates a conversion control signal to control the DC-DC conversion circuit to adjust the system output signal for meeting a power requirement;
wherein the first resonant frequency is different from the second resonant frequency.

9. The multi-mode wireless power receiver circuit of claim 8, wherein the output power control circuit selects one of or combines the second rectified output signal and the first rectified output signal to generate the combined output signal according to information (1) and (2) below:
(1) the second rectified output voltage, and/or the second rectified output current; and
(2) the first rectified output voltage, and/or the first rectified output current;
wherein the output power control circuit generates the conversion control signal according to the information (1) and (2) to control the DC-DC conversion circuit.

10. The multi-mode wireless power receiver circuit of claim 8, wherein the DC-DC conversion circuit is a linear regulator circuit, a switching buck converter circuit, a switching boost converter circuit, or a switching buck-boost converter circuit.

11. The multi-mode wireless power receiver circuit of claim 8, wherein the output power control circuit generates an over voltage protection signal according to the first rectified output voltage to control a first protection switch of the first resonant circuit for adjusting an impedance of the first or the second resonant circuit for over voltage protection, or generates an over voltage protection signal according to the second rectified output voltage to control a second protection switch of the second resonant circuit for adjusting an impedance of the second resonant circuit for over voltage protection.

12. The multi-mode wireless power receiver circuit of claim 8, wherein the output power control circuit generates a communication control signal to control a first communication switch of the first resonant circuit to adjust an impedance of the first resonant circuit for executing an in-band communication with the first wireless power transmitter circuit, or generates a communication control signal to control a second communication switch of the second resonant circuit to adjust an impedance of the second resonant circuit for executing an in-band communication with the second wireless power transmitter circuit.

13. The multi-mode wireless power receiver circuit of claim 8, wherein the output power control circuit generates a communication control signal to control an out-of-band communication circuit for executing an out-of-band communication with the first wireless power transmitter circuit or the second wireless power transmitter circuit.

14. The multi-mode wireless power receiver circuit of claim 8, wherein the output power control circuit generates an impedance control signal to control a first variable capacitor circuit of the first resonant circuit for controlling an impedance of the first resonant circuit to adjust the first resonant frequency or generates an impedance control signal to control a second variable capacitor circuit of the second resonant circuit for controlling an impedance of the second resonant circuit to adjust the second resonant frequency; wherein each of the first variable capacitor circuit and the second variable capacitor circuit includes:
(1) a varactor diode; or
(2) a capacitor and an impedance control switch connected in series or in parallel.

15. A control method for use in controlling a multi-mode wireless power receiver circuit which comprises: a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; and a DC-DC power conversion circuit, configured to operably convert the second rectified output signal into a DC output signal, wherein the DC output signal includes a DC output voltage and a DC output current; wherein the first resonant frequency is different from the second resonant frequency; the control method comprising:
selecting one of or combining the DC output signal and the first rectified output signal to generate a system output signal; and
generating a conversion control signal to control the DC-DC conversion circuit to adjust the system output signal for meeting a power requirement.

16. The control method of claim 15, wherein the step of selecting one of or combining the DC output signal and first rectified output signal to generate the combined output signal is performed according to information (1) and (2) below:
(1) the second rectified output voltage, and/or the second rectified output current, and/or the DC output voltage, and/or the DC output current; and
(2) the first rectified output voltage, and/or the first rectified output current; and
wherein the conversion control signal is generated according to the information (1) and (2) to control the DC-DC conversion circuit.

17. The control method of claim 15, further comprising: generating an over voltage protection signal according to the first rectified output voltage to control a first protection switch of the first resonant circuit for adjusting an impedance of the first or the second resonant circuit for over voltage protection, or generating an over voltage protection signal according to the second rectified output voltage to control a second protection switch of the second resonant circuit for adjusting an impedance of the second resonant circuit for over voltage protection.

18. The control method of claim 15, further comprising: generating a communication control signal to control a first communication switch of the first resonant circuit to adjust an impedance of the first resonant circuit for executing an in-band communication with the first wireless power transmitter circuit, or generating a communication control signal to control a second communication switch of the second resonant circuit to adjust an impedance of the second resonant circuit for executing an in-band communication with the second wireless power transmitter circuit.

19. The control method of claim 15, further comprising: generating a communication control signal to control an out-of-band communication circuit for executing an out-of-band communication with the first wireless power transmitter circuit or the second wireless power transmitter circuit.

20. The control method of claim 15, further comprising: generating an impedance control signal to control a first variable capacitor circuit of the first resonant circuit for controlling an impedance of the first resonant circuit to adjust the first resonant frequency or generating an impedance control signal to control a second variable capacitor circuit of the second resonant circuit for controlling an impedance of the second resonant circuit to adjust the second resonant frequency; wherein each of the first variable capacitor circuit and the second variable capacitor circuit includes:
(1) a varactor diode; or
(2) a capacitor and an impedance control switch connected in series or in parallel.

21. A control method for use in controlling a multi-mode wireless power receiver circuit which comprises: a first resonant circuit which includes at least a first receiver coil, and is configured to operably receive a first wireless power transmitted by a first wireless power transmitter circuit and convert the first wireless power to a first AC resonant signal, wherein the first resonant circuit has a first resonant frequency; a first rectifier circuit which is coupled to the first resonant circuit, and is configured to operably rectify the first AC resonant signal into a first rectified output signal, wherein the first rectified output signal includes a first rectified output voltage and a first rectified output current; a second resonant circuit which includes at least a second receiver coil, and is configured to operably receive a second wireless power transmitted by a second wireless power transmitter circuit and convert the second wireless power to a second AC resonant signal, wherein the second resonant circuit has a second resonant frequency; a second rectifier circuit which is coupled to the second resonant circuit, and is configured to operably rectify the second AC resonant signal into a second rectified output signal, wherein the second rectified output signal includes a second rectified output voltage and a second rectified output current; and a DC-DC power conversion circuit, configured to operably convert a combined output signal into a system output signal; wherein the first resonant frequency is different from the second resonant frequency; the control method comprising:
selecting one of or combining the second rectified output signal and the first rectified output signal to generate the combined output signal; and
generating a conversion control signal to control the DC-DC conversion circuit to adjust the system output signal for meeting a power requirement.

22. The control method of claim 21, further comprising: generating an over voltage protection signal according to the first rectified output voltage to control a first protection switch of the first resonant circuit for adjusting an impedance of the first or the second resonant circuit for over voltage protection, or generating an over voltage protection signal according to the second rectified output voltage to control a second protection switch of the second resonant circuit for adjusting an impedance of the second resonant circuit for over voltage protection.

23. The control method of claim 21, further comprising: generating a communication control signal to control a first communication switch of the first resonant circuit to adjust an impedance of the first resonant circuit for executing an in-band communication with the first wireless power transmitter circuit, or generating a communication control signal to control a second communication switch of the second resonant circuit to adjust an impedance of the second resonant circuit for executing an in-band communication with the second wireless power transmitter circuit.

24. The control method of claim 21, further comprising: generating a communication control signal to control an out-of-band communication circuit for executing an out-of-band communication with the first wireless power transmitter circuit or the second wireless power transmitter circuit.

25. The control method of claim 21, further comprising: generating an impedance control signal to control a first variable capacitor circuit of the first resonant circuit for controlling an impedance of the first resonant circuit to adjust the first resonant frequency or generating an impedance control signal to control a second variable capacitor circuit of the second resonant circuit for controlling an impedance of the second resonant circuit to adjust the second resonant frequency; wherein each of the first variable capacitor circuit and the second variable capacitor circuit includes:
(1) a varactor diode; or
(2) a capacitor and an impedance control switch connected in series or in parallel.
